(19) United States
(12) Patent Application Publication
(10) Pub. No.: US 2007/0039560 A1
(43) Pub. Date: Feb. 22, 2007

(54) Pet restraining device

(76) Inventor: Fitzgerald Vann Smith, Cranbury, NJ (US)

Correspondence Address: Allen R. Kipnes, Esq.;WATOV & KIPNES, P.C., P.O. Box 247, Princeton Junction, NJ, 08550, US

(21) Appl. No.: 11/506,674

(22) Filed: Aug. 18, 2006

Related U.S. Application Data
(60) Provisional application No. 60/709,895, filed on Aug. 22, 2005.

(51) Int. Cl. A01K 27/00

(52) U.S. Cl. 119/794

(57) ABSTRACT

A restraining device for a pet, includes a harness adapted for fastening to the pet, at least two reels each secured spaced apart from one another on the harness to form a gripping area, the reels having an elongate flexible member retractably wound therein; and the elongate flexible member including a hand-grippable portion positioned in the gripping area between the spaced apart reels, wherein the hand-grippable portion can be pulled away from the harness causing the elongate flexible member to unwind from the respective reels to yield a leash.

### FIELD OF THE INVENTION

The present invention relates generally to pet care product and accessories, and more particularly to a pet restraining device having an integrated retractable leash.

### BACKGROUND OF THE INVENTION

Many people find enjoyment and solace in spending time with their pets and walking them outdoors. In city settings, it is often a necessity for dog owners to walk their dogs. Leash laws are common in many locations. Often, the simple task of walking one's pet can turn into a frustrating endeavor when one cannot find the pet's leash. The majority of pet walking apparatus in existence today require a harness such as a collar and a separate leash that must be physically attached to the harness. The leash cannot stay attached to the pet when not in use, because it would hinder the mobility of the animal as well as allow the user's hands to become soiled.

Accordingly, there is a need for a simple, integrated lightweight pet restraining device comprising a harness and leash combination designed as a single unit. There is a further need for a pet restraining device that is compact and durable for enhanced convenience and utility.

### SUMMARY OF THE INVENTION

The present invention relates generally to a pet restraining device having a harness such as a collar with an integrated leash assembly. The integrated leash assembly of the pet restraining device includes at least two reels attached to the harness in a spaced apart configuration to define a gripping area therebetween. The reels include an elongate flexible member retractably wound therein. The elongate flexible member includes a hand-grippable portion positioned in the gripping area between spaced-apart reels. The user simply operates the leash assembly by grabbing the hand-grippable portion and pulling it away from the harness, which causes the elongate flexible member to unwind from the respective reels to yield a leash in an extended state.

In the retracted state, the hand-grippable portion of the elongate flexible member rests substantially flush against the harness (i.e., substantially parallel to the harness) between the corresponding adjacent reels for providing easy accessibility and a compact profile. Optionally, the hand-grippable portion may be in the form of a strap or a loop for providing a better grip. The pet restraining device of the present invention is designed to provide a lightweight and compact profile that minimally impedes the comfort and aesthetic appearance of the pet, while enhancing the ease of use and convenience for the user.

The harness may be in the form of a neck collar or a body harness, for example. The harness is adjustable and the length of the leash in its extended state can vary. Optionally, the harness may further include an attachment ring that allows a conventional leash to be attached to the restraining device. The pet restraining device of the present invention is relatively straightforward and cost effective to implement.

In one aspect of the present invention, there is provided a restraining device for a pet, which comprises:

a harness adapted for fastening to the pet;

at least two reels each secured spaced apart from one another on the harness to form a gripping area therebetween, the reels having an elongate flexible member retractably wound therein; and

the elongate flexible member including a hand-grippable portion positioned in the gripping area between the spaced apart reels, wherein the hand-grippable portion is movable from the harness causing the elongate flexible member to unwind from the respective reels to yield a leash.

### BRIEF DESCRIPTION OF THE DRAWINGS

The following drawings are illustrative of embodiments of the present invention and are not intended to limit the invention as encompassed by the claims forming part of the application.

FIG. 1 is a top plan view of a pet restraining device for one embodiment of the present invention;

FIG. 2 is a side elevational view of the pet restraining device of FIG. 1 in accordance with the present invention;

FIG. 3 is an exploded detailed top plan view of a leash assembly of the pet restraining device in accordance with the present invention;

FIG. 4 is an exploded detailed side view of the leash assembly of the pet restraining device in accordance with the present invention; and

FIG. 5 is an exploded detailed side view of a leash assembly of a pet restraining device for another embodiment of the present invention.

### DETAILED DESCRIPTION OF THE INVENTION

The present invention is directed to a pet restraining device having a harness such as a collar with an integrated leash assembly. The present invention is designed for use as a mechanical restraint and control device for pets and work animals. The integrated leash assembly of the pet restraining device of the present invention utilizes two or more reels attached to the harness in a spaced apart configuration to define a gripping area therebetween. The reels include an elongate flexible member retractably wound therein. The elongate flexible member includes a hand-grippable portion position in the gripping area between the spaced-apart reels, which can be pulled to extend the elongate flexible member, thus quickly generating a leash.

The multiple reel configuration of the present invention provides effective distribution of load for better wear resistance and enhanced strength capacity to the pet restraining device, while helpfully distributing weight on the harness for better wear comfort on the pet. Therefore, the pet restraining device of the present invention is especially designed to provide a lightweight and compact profile that minimally impedes the comfort and aesthetic appearance of the pet, while enhancing the ease of use and convenience for the user. Furthermore, the pet restraining device of the present invention is relatively straightforward and cost effective to fabricate and implement.

Broadly, there is generally provided a restraining device for a pet, which comprises a harness adapted for fastening to the pet, at least two reels each secured spaced apart from one another on the harness to form a gripping area therebetween with the reels housing an elongate flexible member retractably wound therein. The elongate flexible member includes a hand-grippable portion positioned in the gripping area between the spaced apart reels, wherein the hand-grippable portion is movable from the harness causing the elongate flexible member to unwind from the respective reels to yield a leash.

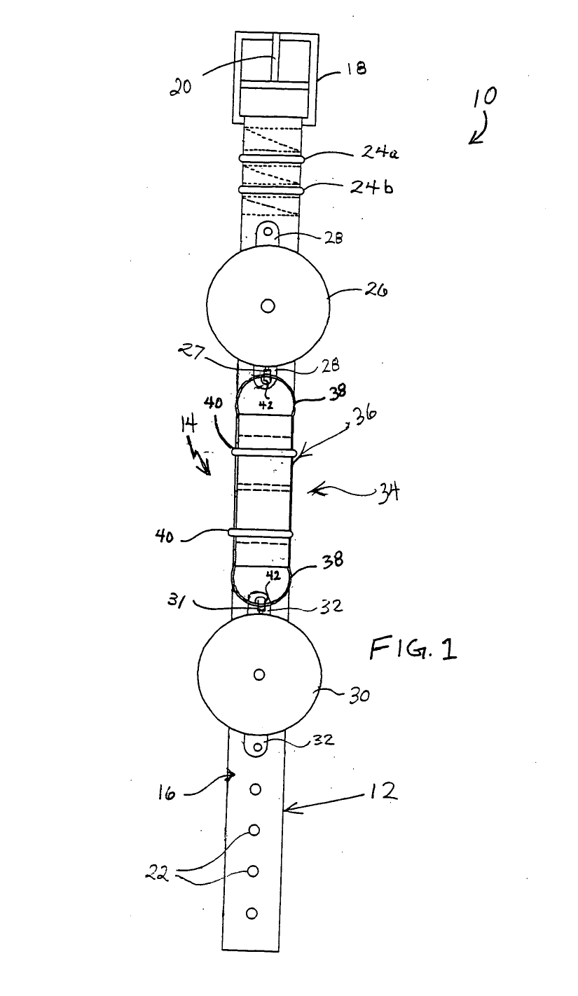

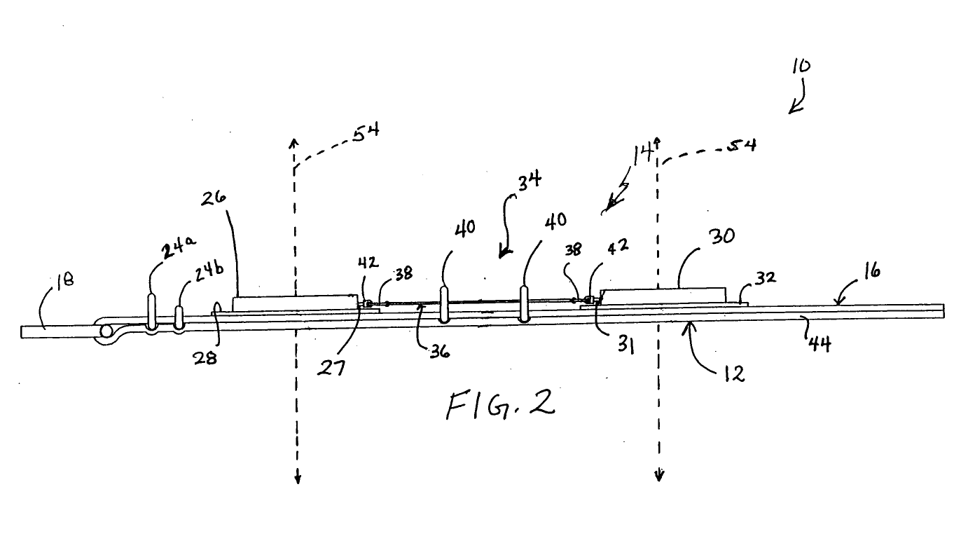

Referring to FIGS. 1 and 2, there is shown a pet restraining device for one embodiment of the present invention, which is designated generally by the reference numeral 10. The pet restraining device 10 comprises a harness 12 shown in the form of a standard neck collar, and a leash assembly 14 attached to the outside surface of the harness 12. It will be understood that other type of harness devices are contemplated herein.

The harness 12 includes a strap body 16 having a buckle 18 with a movable prong 20 at one end, and a series of linearly spaced apertures 22 at the other end through one of which the buckle prong 20 is inserted to fasten the ends of the strap body 16 together. The length of the strap body 16 is sufficient to extend comfortably around the pet's neck. Such lengths may vary from 36 to 52 inches depending on the size of the pet's neck. Optionally, the harness 12 may further include one or more attachment rings 24a and 24b for providing an attachment point(s) for a conventional leash and/or identification tags.

Although the harness 12 is described in the context of a neck collar, the term “harness” is intended to encompass any device fashioned from a length of a suitable flexible, durable lightweight material used to conventionally secure a pet or work animal to a tether or an anchor point. Such suitable flexible, durable lightweight materials may including, but are not limited to, leather, metal, synthetic materials such as nylon, polyester, rayon, and the like, and natural materials such as linen, hemp, canvas, cotton, jute, wool, sisal, and the like. Examples of suitable harnesses include, for example, those in the form of a head collar, a body harness, an assistance dog harness, or a sled dog harness such as freight harness, H-back harness, and X-back harness, and the like.

The leash assembly 14 comprises at least two reels. For purposes of illustration, the drawings show and the invention will be described using two reels. There is shown a first reel 26 housing an elongate flexible member 27 wound therein, attached to the strap body 16 of the harness 12 via a mounting bracket 28. A second reel 30 house an elongate flexible member 31 wound therein, attached spaced apart from the first reel 26 to the strap body 16 via a mounting bracket 32. The two reels 26 and 30 are suitably spaced-apart to define a gripping area 34 therebetween.

A flexible hand-grippable strap 36 is securely fastened at each end thereof to a corresponding elongate flexible member 27 or 31. The leash assembly 14 may further include a securing assembly (not shown) in the gripping area for securing the hand-grippable strap 36 to the harness 12. The securing assembly (not shown) may be in the form of a snap assembly, a clip assembly, a button assembly, a clasp assembly, a strap assembly, a tie assembly, a pin assembly, a grommet assembly, a hook and loop fastener assembly, or a magnet assembly.

The term “reel” is intended to mean any device comprising a cylindrical core or spool around which a length of an elongate flexible material is wound for storage, and optionally a housing enclosing the core and an opening through which the elongate flexible material extends. The reels 26 and 30 may be configured for either manual or automatic retraction of the elongate flexible members 27 and 31, respectively. Such manual or automatic retraction reels are known in the art such as those found, for example, in self-retracting tape measures and in key chain reels, and are commercially available, off the shelf. A suitable reel may be selected from the KEY-BAK™ line of reels manufactured and sold by West Coast Chain Manufacturing Co. of Ontario, Canada.

Each of the reels. 26 and 30 includes a cylindrical core (not shown) around which the elongate flexible material 27 and 31, respectively, is wound, and an axis of rotation 54 (as shown in FIG. 2) corresponding to the cylindrical cores or spools (not shown). Preferably, the reels 26 and 30 are oriented with the axis of rotation 54 normal or perpendicular to the immediate portion of the harness 12. This orientation provides a compact and subtle appearance to the pet restraining device 10.

The reels 26 and 30 may be mechanically configured with a spring-loaded retractable mechanism (not shown) for automatically retracting the elongate flexible members 27 and 31, respectively. The user can pull the elongate flexible members 27 and 31 into an extended state to produce a leash. Upon release by the user, the spring-loaded retractable mechanisms (not shown) of the reels 26 and 30, respectively, retract the elongate flexible members 27 and 31 back to the original position. In the retracted state, the hand-grippable strap 36 rests substantially flush against the strap body 16 of the harness 12 (i.e., substantially parallel thereto) between the corresponding adjacent reels 26 and 30 for providing easy accessibility and compactness. Optionally, the hand-grippable strap 36 may be in the form of a loop wherein the end rings 38 may move freely about the loop.

Alternatively, the retraction mechanism (not shown) may further include a conventional ratchet assembly (not shown) operatively associated with the reel 27 or 31. The ratchet assembly (not shown) allows the user to pull the hand-grippable strap 36 out to a desired distance for producing a fixed length leash. The ratchet assembly (not shown) prevents automatic retraction of the elongate flexible member back until disengaged by the user. Such devices are well known and commercially available.

The elongate flexible members 27 and 31 each further include a cable swivel 42 respectively attached to the ends thereof. The hand-grippable strap 36 is fastened to the respective elongate flexible members 27 and 31 through an end ring 38 at each end thereof coupled to the cable swivels 42, respectively. The leash assembly 14 further includes a pair of spaced-apart retaining rings 40 secured to the strap body 16 of the harness 12. The hand-grippable strap 36 is positioned within the retaining rings 40. The retaining rings 40 enhance the direction of the force exerted on the reels 26 and 30 through the elongate flexible members 27 and 31, respectively, to minimize wear and tear, as will be described hereinafter.

The elongate flexible members 27 and 31 extending from the reels 26 and 30, respectively, each exhibit sufficient tensile strength to accommodate the force generated by the pet pulling on the leash, and to resist breakage and/or wear over long-term use. The selected tensile strength of the elongate flexible members and the strength rating of the reels will depend on the size and weight of the pet. The elongate flexible members 27 and 31 can be in a form selected from a cord, a cable, a rope, a ribbon, a strap, a filament, a twine, a wire, and the like. Any suitable material can be used to fabricate the elongate flexible members including, but not limited to stainless steel, KEVLAR, plastic, synthetic and natural fibers, and the like.

Referring specifically to FIG. 2, the strap body 16 of the harness 12 is formed by folding a strap material 44 in half. The buckle 18, the attachment rings 24a and 24b, and the retaining rings 40 are suitably positioned between the two layers of strap material 44, and retained in place by suitable fastening means such as through stitching. Seam stitches are applied at appropriate places of the strap material 44 to keep the strap body 16 in an intact unitary form with minimal gaps. The leash assembly 14 is mounted securely to the top surface of the strap body 16 using any suitable means including riveting, adhesives, and the like.

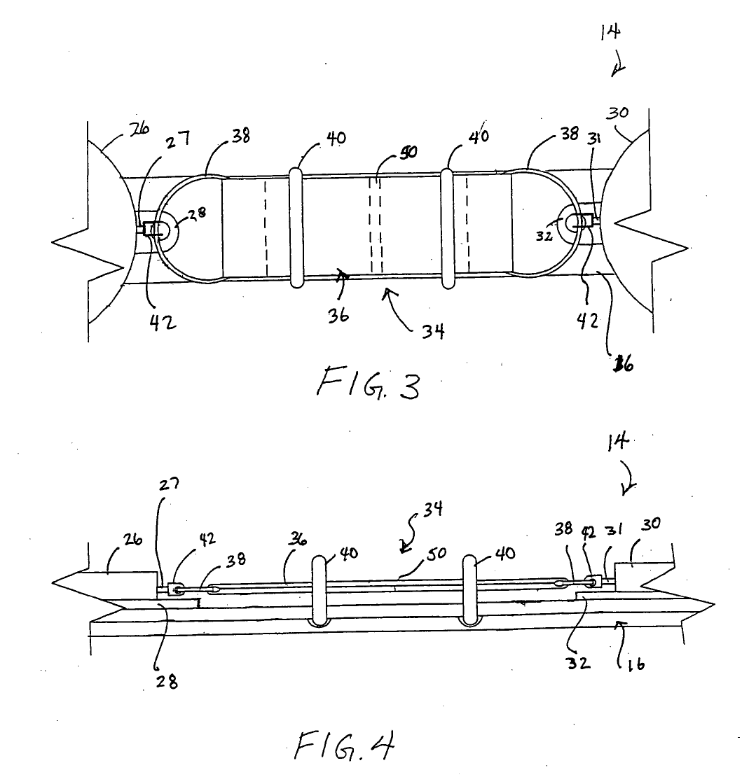

Referring to FIGS. 3 and 4, the reels 26 and 30 of the leash assembly 14 define therebetween the gripping area 34. The hand-grippable strap 36 is centrally positioned in the gripping area 34. The retaining rings 40 are positioned spaced-apart on opposite sides of the central portion 50 of the hand-grippable strap 36. The retaining rings 40 permit the user to pull the hand-grippable strap 36 therebetween away from the harness 12, while maintaining the direction of the force on the unwinding elongate flexible members 27 and 31 in the same plane as the reels 26 and 30, respectively. This greatly reduces premature wear and tear on the reels 26 and 30, and the corresponding elongate flexible members 27 and 31, respectively.

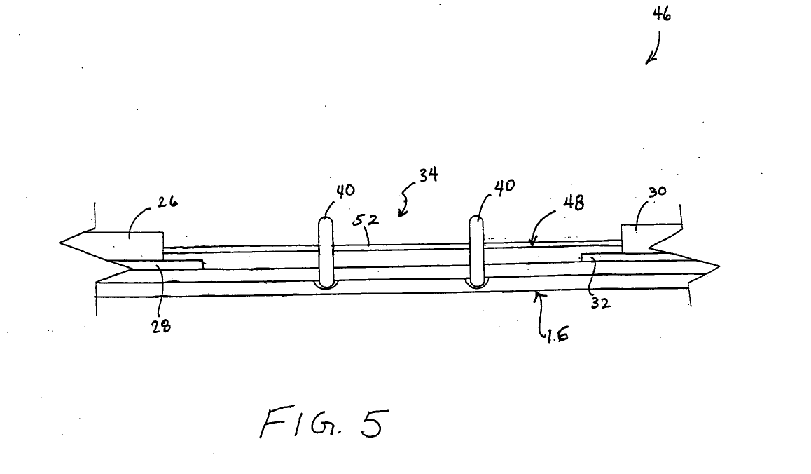

Referring to FIG. 5, a leash assembly 46 is shown for another embodiment of the present invention. The leash assembly 46 is similar in almost all features as the leash assembly 14 described above. However, the reels 26 and 30 share a single unitary elongate flexible member 48 therebetween. The user can grasp a hand-holdable portion 52 of the elongate flexible member 48 occupying the gripping area 34 to produce a quick leash. A hand-grippable strap can be used to encompass the hand-holdable portion 52 of the elongate flexible member 48 to provide better grippage and comfort.

The pet restraining device of the present invention may be configured to include three reels suitably arranged on the harness (e.g., triangular arrangement) to yield a leash comprising three elongate flexible members linked to form a hand-grippable portion. Alternatively, the pet restraining device may include multiple pair of reels to yield multiple leashes on the same harness as desired.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. A restraining device for a pet, comprising:
a harness adapted for fastening to the pet;
at least two reels each secured spaced apart from one another on the harness to form a gripping area therebetween, said reels having an elongate flexible member retractably wound therein; and
said elongate flexible member including a hand-grippable portion positioned in said gripping area between the spaced apart reels, wherein the hand-grippable portion is movable from the harness causing the elongate flexible member to unwind from the respective reels to yield a leash.

2. The restraining device of claim 1 wherein the elongate flexible member is in a form selected form the group consisting of a cord, a cable, a rope, a ribbon, a strap, a filament, a twine, and a wire.

3. The restraining device of claim 1 wherein each of the reels comprises a retraction mechanism for automatically retracting the elongate flexible member from said position away from the harness.

4. The restraining device of claim 1 wherein the harness comprises securing means for releasably securing the hand-grippable portion to the harness with the elongate flexible member in the retracted state.

5. The restraining device of claim 4 wherein the securing means is in the form selected from the group consisting of a snap assembly, a clip assembly, a button assembly, a clasp assembly, a strap assembly, a tie assembly, a pin assembly, a grommet assembly, a hook and loop fastener assembly, and a magnet assembly.

6. The restraining device of claim 1 wherein the hand-grippable portion of the elongate flexible member is in the form of a strap.

7. The restraining device of claim 1 wherein the hand-grippable portion of the elongate flexible member is in the form of a loop.

8. The restraining device of claim 1 further comprising retaining means for retaining portions of the elongate flexible member substantially parallel with the harness as the elongate flexible members move away from the harness and are retracted within the respective reels.

9. The restraining device of claim 8 wherein the retaining means comprises a pair of spaced-apart retaining rings attached to the harness, said hand-grippable portion of the elongate flexible member positioned between the retaining rings.

10. The restraining device of claim 9 wherein the elongate flexible member comprises a non-grippable portion positioned between respective reels and respective retaining rings, said non-grippable portion remaining substantially parallel to the harness when the hand-grippable portion is moved away from the harness.

11. The restraining device of claim 1 wherein the harness is in the form of a collar.

12. The restraining device of claim 11 wherein the collar comprises fastening means for fastening the ends thereof around a pet's neck.

13. The restraining device of claim 1 wherein each of the reels comprises an axis of rotation perpendicular to the immediate portion of the harness.
